(19) United States
(12) Patent Application Publication
(10) Pub. No.: US 2010/0315071 A1
(43) Pub. Date: Dec. 16, 2010

(54) READ HEAD

(76) Inventors: Timo GALM, Mudau (DE); Thomas Freund, Mannheim (DE)

Correspondence Address: Muncy, Geissler, Olds & Lowe, PLLC, 4000 Legato Road, Suite 310, FAIRFAX, VA, 22033, US

(21) Appl. No.: 12/813,159

(22) Filed: Jun. 10, 2010

Related U.S. Application Data
(60) Provisional application No. 61/185,971, filed on Jun. 10, 2009.

(30) Foreign Application Priority Data
Jun. 10, 2009 (EP) EP 09007683.7

(51) Int. Cl. G01B 7/00

(52) U.S. Cl. 324/207.15

(57) ABSTRACT

A read head with a sensor unit, whereby the sensor unit has a first RFID transponder reader unit and an induction detector unit. With the combination of two types of reader units, read heads of this type can be used for determining the position of rail vehicles.

This nonprovisional application claims priority to EP Application No. 09007683.7, which was filed on Jun. 10, 2009, and to U.S. Provisional Application No. 61/185,971, which was filed on Jun. 10, 2009, and which are both herein incorporated by reference.

### BACKGROUND OF THE INVENTION

1. Field of the Invention

The invention relates to a read head and to a use of a read head.

2. Description of the Background Art

A read head is disclosed, for example, in DE 10 2006 004 938 A1 as part of the described position determining system and is used in particular for determining the position of a motor vehicle. RFID transponders are used as transducers for the read head. Another read head is known from WO 2008/101702. In this case, to determine the position of a rotating wheel by means of the read head the induction of magnets arranged on the rotating wheel is determined. Another read head is known from the position determining system in DE 10 2008 044 739 A1. In this case, the position of a first object relative to a second object is determined by means of an inductive displacement sensor. To this end, the read head or the sensor unit in the read head passes near a marking section realized as a transducer unit. Another device and method for determining the position is known from WO 2005/012840, which corresponds to U.S. Pat. No. 7,245,121, and which is incorporated herein by reference. In this case, the induction brought about by a permanent magnet in the sensor is evaluated in a read head by means of a sensor. In so doing, the sensor unit arranged on the read head is capable of determining the induction of several magnets simultaneously.

Another position determining system is disclosed in EP 0 472 028 A2. In this case, RFID marks are detected by means of an RFID read unit on a carrier device to bring about changes in direction or stops of the carrier device. Further, an inductively operating detector unit is used to detect a deviation from a preferred direction. Other systems are disclosed U.S. Pat. Appl. No. 2002/0129508 A1 and in EP 1 577 188 A2, which corresponds to U.S. Pat. No. 7,426,424.

A drawback of the conventional read heads is that the position can be determined only imprecisely and/or the construction of a position determining system with use of conventional read heads in conjunction with the appropriate transducer units is cost-intensive during manufacture and use. The conventional solutions are also not sufficient during use of conventional read heads in a positioning system in a rail vehicle, particularly when, for example, in the case of crane units in harbor areas several 100 m must be traversed by a crane. This also applies during use as a read head as a speed sensor in rings with diameters greater than several meters.

### SUMMARY OF THE INVENTION

It is therefore an object of the invention to provide a read head and a use for a read head, which in each case reduce the disadvantages of the conventional art.

In an embodiment, a read head with a sensor unit is provided, whereby the sensor unit has a first RFID transponder reader unit and an induction detector unit, and the read head has a longitudinal axis, and the read head can be moved along the longitudinal axis, and during the movement to determine the specific position a first part of a position datum is determined by means of the read unit and a second part of the position datum by means of the induction detector unit, and the read unit and the induction detector unit are arranged in a line running substantially parallel to the longitudinal axis.

According to another embodiment, a use of the read head is disclosed for determining the position of positively guided vehicles, particularly of rail vehicles, whereby the guiding device has at least one transducer unit.

An advantage of the read head of the invention is that particularly in conjunction with a suitable transducer unit, which has at least one RFID transponder and a metallic material, a very reliable and precise position determining system can be provided. An advantage of a position determining system of this type, furthermore, is that by means of the combination of two different types of sensors in the read head or two types of transducers, the accuracy of the position determination by means of the read head is increased, particularly also at distances greater than 10 m, preferably greater than 100 m, in that the position data can be determined very precisely by means of the read head from a row arrangement of the individual transducer units. In this case, the position can be determined for each position from a first part of a position datum and a second part of the position datum. As a result, the specific position of the read head includes a first part and a second part. Preferably, the read unit and the detector unit are formed on a line running substantially parallel to a longitudinal axis of the read head. Tests by the applicant have shown that using RFID transponders as transducers opens up a simple and reliable possibility to provide the necessary data simply and reliably to the read head or the two different types of reader units arranged therein in the case of an inquiry. In this case, it is advantageous to use on the transducer side simple cost-effective passive RFID transponders, which do not have their own current supply. The RFID transponders preferably operate within the range of 125 KHz, most preferably within the range of 13.5 MHz, and obtain the necessary power from the field of the RFID transponder reader unit. HF RFID transponders as well, which operate backscatter-based within the range above 800 MHz, can also be used. The individual RFID transponders have a unique identification by which a definite position can be assigned to the particular RFID transponders in the sensor unit. The RFID transponders can be programmed especially simply with a consecutive sequence of numbers and these can be read by the read head. If the distance between two successive RFID transponders is known, an absolute position can be easily determined by the RFID transponder reader unit and in addition by means of the induction detector unit due to a change in the induction in the vicinity of a metallic material, for example, by induction of eddy currents in the metallic material, at least one relative position of the sensor unit with respect to the RFID transponder can be determined; i.e., the position can be determined from a combination of RFID transponder data and the change in induction caused by the metallic material. It is understood that metallic materials that cause an especially strong induction in a magnetic field are to be preferred.

As during use of a read head of this type in a position determining system, the data of the transducer unit can be determined without contact and without optical aids, the read head or the system is robust and not sensitive to soiling. Furthermore, it is advantageous, particularly for use in security-related systems, that in each position in which an RFID transponder can be read out, the absolute position of the reader unit can be determined without a reference point having to be approached or the last position having to be stored. This is an advantage particularly during a power outage in that an absolute position can easily be determined.

In an embodiment, during the movement the position data are determined continuously. As a result, the specific position can be determined at any time at all points during a movement. Preferably, a rough position is determined by means of the first part and a fine position by means of the second part of the position datum. Tests by the applicant have shown that an absolute position can be determined by means of the first part of the position datum and the second part of the position datum.

In another embodiment, the sensor unit of the read head comprises a second RFID transponder reader unit. In a suitable arrangement, the reader unit can read the data of two RFID transponders, as a result of which the security and accuracy during the position determination increase. Tests by the applicant have shown that it is advantageous to arrange the induction detector unit between the first and second RFID transponder reader unit within the sensor unit of the read head. The sensor unit can be used especially advantageously in security-related systems because of the redundancy of the sensors arranged on the sensor unit. If, for example, namely the induction detector unit fails, the position, albeit if need be with a lower accuracy, can continue to be determined reliably with use of one or both RFID transponder reader units.

In another embodiment, it is advantageous to arrange a plurality of induction detector units between the first and second RFID transponder reader unit. According to another preferred refinement, it is advantageous to provide within a read head an alternating arrangement of a plurality of RFID transponder reader units and a plurality of induction detector units and that the length of the read head has at least the length of a transducer unit, having at least one first metallic material, which is arranged between a first RFID transponder and a second RFID transponder.

It was found that preferably the sensor unit in the direction of transducer units, for instance arranged on a rail, has a longitudinal axis formed substantially parallel to the longitudinal direction of the rail. Further, the read unit and the detector unit, i.e., the induction detector unit, are arranged in a line formed substantially parallel to the longitudinal axis.

According to another embodiment, the read head has the same number of induction detector units, located between two successive RFID transponder reader units, as metallic materials arranged between two successive RFID transponders in the transducer unit. As a result, the data from an individual transducer unit can be completely determined by the read head, without the read head having to be moved relative to the transducer unit to determine the data.

In connection with a row arrangement of a plurality of transducer units and the design of an alternating arrangement of RFID transponder and metallic materials, a position determining system can be constructed for a precise determination of the position, also in the case of lengths of several 100 m. It is preferred in this case to arrange the transducer units on a bar, whereby an RFID transponder each is formed at the end and beginning of the bar. Tests by the applicant have shown that in the case of transducer units arranged on a strip, the strip with the transducer units can be attached cost-effectively and continuously to a bar, for example, by a gluing process. If the read head is arranged on a motor vehicle, particularly rail vehicle, the position of the rail vehicle can be determined simply and reliably. The term rail vehicle covers all positively guided systems, regardless of their geometric configuration. Tests by the applicant have shown in particular that the read head of the invention can be used preferably also in positioning systems in the case of rings with a diameter greater than several meters.

In another embodiment, the read head comprises evaluation electronics for outputting the position using data determined by a transducer unit. It is preferred, furthermore, to arrange the evaluation electronics on a plate above the sensor units. It is preferred, further, that the sensor unit of the read head has such a length that at each position both the data of at least one RFID transponder are determined and the induction of at least one metallic material is received. It is also advantageous that a rough position is determined by means of the RFID transponder data by the sensor unit, and a fine position of the sensor unit is determined by means of the induction data of the induction detector unit caused by the change in the induction of a transmitted magnetic field, when eddy currents are induced in the metallic material formed as a transducer unit.

In an embodiment, the metallic material of the transducer unit can also be made as a permanent magnet. As a result, the sending out of a variable magnetic field by the induction detector unit is unnecessary. Instead, a Hall sensor is used as an induction detector unit for detecting the magnetic field.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a top view of a first embodiment of a row arrangement of a plurality of transducer units;

FIG. 2 shows a top view of a first embodiment of a read head;

FIG. 3 shows a side view of a position determining system of the invention;

FIG. 4 shows a top view of second first embodiment of a row arrangement of a plurality of transducer units; and

FIG. 5 shows a top view of a second embodiment of a read head.

### DETAILED DESCRIPTION

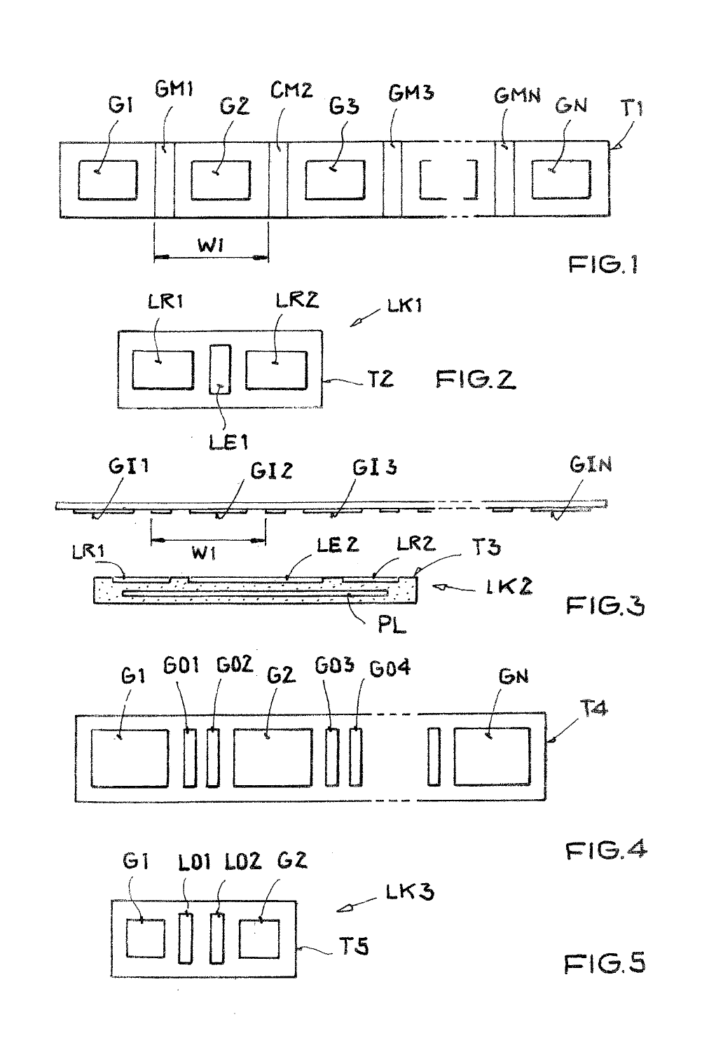

The illustration in FIG. 1 shows a top view of a first schematic embodiment of a row arrangement of transducer units arranged on a support T1. The support T1 is formed preferably as a flexible strip which preferably can be unrolled from a roll. A first transducer unit GK1 includes an RFID transponder G1 and a metallic material GM1. Accordingly, the following transducer units comprise an RFID transponder G2 and a metallic material GM2 or an RFID transponder G3 and a metallic material GM3, and the last transducer unit an RFID transponder GMN-1 and a metallic material GMN-1. The row arrangement of transducer units, which represents an alternating arrangement of RFID transponders and metallic materials, is ended by an RFID transponder GN. The length of a transducer unit is W1 and simultaneously represents the degree of repetition in the row arrangement of transducer units. So that the degree of repetition does not vary if possible from transducer unit to transducer unit and the accuracy of the position determination is not negatively affected, the strip is to be made as nonexpandable as possible in the longitudinal direction.

The illustration in FIG. 2 shows a top view of a schematic embodiment of a read head with a sensor unit LK1. The sensor unit LK1 comprises a first RFID transponder reader unit LR1, a first induction detector unit LE1, and a second RFID transponder sensor unit LR2. Further, the reader units are arranged on a support T2.

The illustration in FIG. 3 shows a schematic side view of a position determining system of the invention, having a row arrangement of transducer units, as already explained in relation to the drawing documents depicted in FIG. 1, and a read head with a second sensor unit LK2 with the first RFID transponder reader unit LR1 and a first induction detector unit LE2 and the second RFID transponder reader unit LR2 arranged on a support T3. Further, the sensor unit LK2 comprises a plate PL likewise arranged on support T3 for accommodating evaluation electronics. The distance of the sensor unit LK2 to the transducer units arranged on the top side of support T1 is selected in such a way that the data of the RFID transponder and the change in induction due to the metallic material are reliably determined. The distance is preferably within the range of a few centimeters. Further, the sensor unit LK2 can be moved relative to the row arrangement of transducer units.

The illustration in FIG. 4 shows a top view of a second schematically depicted embodiment of a row arrangement of transducer units which are formed on a support T4. Hereafter, only the differences to the first embodiment, explained in relation to the description of the illustration in FIG. 1, are described. Accordingly, a transducer unit GK2 comprises the transponder G1 and two successive areas with a metallic material G01 and G02. The distances between the metallic materials are selected in such a way that the sensor unit can achieve the best possible spatial resolution.

In the illustration in FIG. 5, a top view of a second schematically depicted embodiment of a read head with a third sensor unit LK3, arranged on a support T5, is shown. Hereafter, only the differences to the first embodiment, explained in relation to the description of the illustration in FIG. 2, are described. Accordingly, the third sensor unit LK3 comprises a first induction detector unit LO1 and a second induction detector unit LO2. Both induction detector units LO1 and LO2 are formed between the two RFID transponder reader units LR1 and LR2. The arrangement of the two induction detector units LO1 and LO2 is adapted particularly to the second embodiment of a transducer unit, shown in FIG. 4, to detect the two metallic materials arranged between the RFID transponders.

Further, the third sensor unit LK3 can also be used for the embodiment of a transducer unit with only one metallic material arranged between two RFID transponders. Likewise, the sensor unit LK2 or LK1 can also be used for the transducer unit, explained in relation to the drawing documents of FIG. 4.

It is understood that for the geometric configuration of the read head and the sensor unit a rectangular configuration is preferred in which the read unit and the detector unit are arranged on a line substantially parallel to the longitudinal axis of the read head. The longitudinal axis in turn points in the direction of the row of transducer units.

What is claimed is:

1. A read head with a sensor unit, the sensor unit comprising:
a first RFID transponder reader unit; and
an induction detector unit,
wherein the read head has a longitudinal axis and is moveable along the longitudinal axis,
wherein during a movement of the read head, a specific position is determined of a first part of a position datum by the read unit and a second part of the position datum is determined by the induction detector unit, and
wherein the read unit and the induction detector unit are arranged in a line running substantially parallel to the longitudinal axis.

2. The read head according to claim 1, wherein during the movement the position data are determined continuously.

3. The read head according to claim 1, wherein a rough position is determined by the first part and a fine position by the second part.

4. The read head according to claim 1, wherein an absolute position is determined by the first part of the position datum and the second part of the position datum.

5. The read head according to claim 1, wherein the sensor unit comprises a second RFID transponder reader unit.

6. The read head according to claim 5, wherein the induction detector unit is arranged between the first and second RFID transponder reader unit.

7. The read head according to claim 5, wherein a plurality of induction detector units are arranged between the first and second RFID transponder reader unit.

8. The read head according to claim 5, wherein the read head has an alternating arrangement of a plurality of RFID transponder reader units and a plurality of induction detector units.

9. The read head according to claim 1, wherein a length of the read head has at least a length of a transducer unit, having at least one first metallic material, which is arranged between a first RFID transponder and a second RFID transponder.

10. The read head according to claim 1, wherein the read head has the same number of induction detector units located between two successive RFID transponder reader units as metallic materials arranged between two successive following RFID transponders in the transducer unit.

11. The read head according to claim 1, wherein the read head comprises evaluation electronics for outputting the position using the data determined by a transducer unit.

12. The read head according to claim 1, wherein the evaluation electronics are arranged on a plate above the sensor units.

13. The read head according to claim 1, wherein the sensor unit is mounted on a motor vehicle.

14. A use of the read head according to claim 1 for determining the position of positively guided vehicles, particularly of rail vehicles, whereby the guiding device has at least one transducer unit.
